(19) United States
(12) Patent Application Publication
(10) Pub. No.: US 2025/0063334 A1
(43) Pub. Date: Feb. 20, 2025

(54) DISCOVERY PROCEDURE FOR RELAY OPERATION IN WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Bilal Sadiq, Plano, TX (US); Matthew Tonnemacher, Plano, TX (US); Yue Qi, Plano, TX (US); Rubayet Shafin, Allen, TX (US); Vishnu Vardhan Ratnam, Frisco, TX (US); Elliot Jen, Taipei (TW)

(21) Appl. No.: 18/789,548

(22) Filed: Jul. 30, 2024

Related U.S. Application Data
(60) Provisional application No. 63/533,478, filed on Aug. 18, 2023.
(60) Provisional application No. 63/537,292, filed on Sep. 8, 2023.
(60) Provisional application No. 63/545,246, filed on Oct. 23, 2023.

(51) Int. Cl. H04W 8/00; H04W 8/20; H04W 88/04

(52) U.S. Cl. CPC H04W 8/005; H04W 8/205; H04W 88/04

(57) ABSTRACT

A first device associated with a second device in a wireless network, the first device comprising at least one station (STA) affiliated with the first device and a processor coupled to the at least one STA, the processor configured to determine a relay node that can perform one or more relay operations to communicate with the first STA, transmit, to a second STA, a first frame that includes information regarding the relay node that can be used to communicate with the first STA, and communicate with the second STA via the relay node.

### CROSS-REFERENCE TO RELATED APPLICATIONS

This application claims the benefit of priority from U.S. Provisional Application No. 63/533,478, entitled “Discovery Procedure for Relay Operation in Next Generation Wi-Fi Networks” filed Aug. 18, 2023, U.S. Provisional Application No. 63/537,292, entitled “Procedures for Latency Reduction for Relay Operation in Next Generation Wi-Fi Network” filed Sep. 8, 2023, and U.S. Provisional Application No. 63/545,246, entitled “Relay Operation with Legacy AP” filed Oct. 23, 2023, all of which are incorporated herein by reference in their entireties.

### TECHNICAL FIELD

This disclosure relates generally to a wireless communication system, and more particularly to, for example, but not limited to, discovery procedures for relay operations in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first station (STA) in a wireless network. The first STA comprises a memory and a processor coupled to the memory. The processor is configured to determine a relay node that can perform one or more relay operations to communicate with the first STA. The processor is configured to transmit, to a second STA, a first frame that includes information regarding the relay node that can be used to communicate with the first STA. The processor is configured to communicate with the second STA via the first relay node.

In some embodiments, the first STA is an access point (AP) and the second STA is a non-AP STA.

In some embodiments, to communicate with the second STA, the processor is further configured to receive a second frame from the second STA that has been forwarded by the relay node.

In some embodiments, the processor is further configured to receive, from the relay node, a second frame that includes information regarding capabilities of the relay node.

In some embodiments, the processor is further configured to receive, from the relay node, a second frame that includes information on one or more access points (APs) and STAs that can communicate with the relay node.

In some embodiments, the second STA is included in the information in the second frame.

In some embodiments, the first frame includes information on a plurality of relay nodes that can be used to connect to the first STA.

In some embodiments, the first frame includes signal strength information and communication speed information for the relay node.

In some embodiments, the processor is further configured to transmit a second frame to one or more STAs that advertises one or more relay nodes that can be used to communicate with the first STA.

In some embodiments, the processor is further configured to transmit a second frame to one or more STAs to check which of the one or more STAs can perform relay operations to relay communications to the first STA, and receive a third frame from a third STA in the one or more STAs that indicates that the third STA can perform relay operations to relay communications to the first STA.

One aspect of the present disclosure provides a relay node in a wireless network. The relay node comprises a memory and a processor coupled to the memory. The processor is configured to determine an ability to perform one or more relay operations to communicate with one or more STAs. The processor is configured to transmit, to a first STA, a first frame that includes information regarding the one or more STAs the relay node can communicate with. The processor is configured to receive, from the first STA, a second frame that is to be transmitted to a second STA. The processor is configured to transmit, to the second STA, the second frame.

In some embodiments, the relay node is an access point (AP) and the first STA is a non-AP STA.

In some embodiments, the first frame includes information regarding capabilities of the relay node.

In some embodiments, the second STA is included in the information regarding one or more STAs that the relay node can communicate with.

In some embodiments, the first frame includes signal strength information and communication speed information for the relay node.

One aspect of the present disclosure provides a computer-implemented method for facilitating communication at a first station (STA) in a wireless network. The method comprises determining a relay node that can perform one or more relay operations to communicate with the first STA. The method comprises transmitting, to a second STA, a first frame that includes information regarding the relay node that can be used to communicate with the first STA. The method comprises communicating with the second STA via the first relay node.

In some embodiments, the first STA is an access point (AP) and the second STA is a non-AP STA.

In some embodiments, the method further comprises receiving, to communicate with the second STA, a second frame from the second STA that has been forwarded by the relay node.

In some embodiments, the method further comprises receiving, from the relay node, a second frame that includes information regarding capabilities of the relay node.

In some embodiments, the method further comprises receiving, from the relay node, a second frame that includes information on one or more access points (APs) and STAs that can communicate with the relay node.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates a flow chart of an example advertisement procedure in accordance with an embodiment.

FIG. 5 illustrates a relay advertisement element in accordance with an embodiment.

FIG. 6 illustrates a relay control field format in accordance with an embodiment.

FIG. 7 illustrates a flowchart of an AP side advertisement procedure in accordance with an embodiment.

FIG. 8 illustrates an advertisement element format in accordance with an embodiment.

FIG. 9 illustrates an AP control field format in accordance with an embodiment.

FIG. 10 illustrates a flowchart of an example process of an AP side query based search in accordance with an embodiment.

FIG. 11 illustrates an element format for query transmission in accordance with an embodiment.

FIG. 12 illustrates a query control field format in accordance with an embodiment.

FIG. 13 illustrates a control frame format for query message in accordance with an embodiment.

FIG. 14 illustrates a query control field format in accordance with an embodiment.

FIG. 15 illustrates a query information field format in accordance with an embodiment.

FIG. 16 illustrates an A-control subfield format in accordance with an embodiment.

FIG. 17 illustrates a flow chart of a relay side response procedure in accordance with an embodiment.

FIG. 18 illustrates a control frame format for response query in accordance with an embodiment.

FIG. 19 illustrates a response control field format in accordance with an embodiment.

FIG. 20 illustrates a response information field format in accordance with an embodiment.

FIG. 21 illustrates a format for A-control subfield variant in accordance with an embodiment.

FIG. 22 illustrates an element-based request and response operation in accordance with an embodiment.

FIG. 23 illustrates a control frame-based operation in accordance with an embodiment.

FIG. 24 illustrates an A-control subfield operation in accordance with an embodiment.

FIG. 25 illustrates passive discovery in accordance with an embodiment.

FIG. 26 illustrates an operation using capability advertisement during association in accordance with an embodiment.

FIG. 27 illustrates operation based on STA side probing in accordance with an embodiment.

FIG. 28 illustrates an STA side relay search request in accordance with an embodiment.

FIG. 29 illustrates a procedure for priority access for relay in accordance with an embodiment.

FIG. 30 illustrates a flow chart of an example process for priority access for a STA in accordance with an embodiment.

FIG. 31 illustrates an enhanced transmission procedure in accordance with an embodiment.

FIG. 32 illustrates an AP info message element format in accordance with an embodiment.

FIG. 33 illustrates a preferred AP indication message format in accordance with an embodiment.

FIG. 34 illustrates a preferred AP confirmation message format in accordance with an embodiment.

FIG. 35 illustrates operations when a relay is a mobile AP in accordance with an embodiment.

FIG. 36 illustrates a vendor specific element format in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

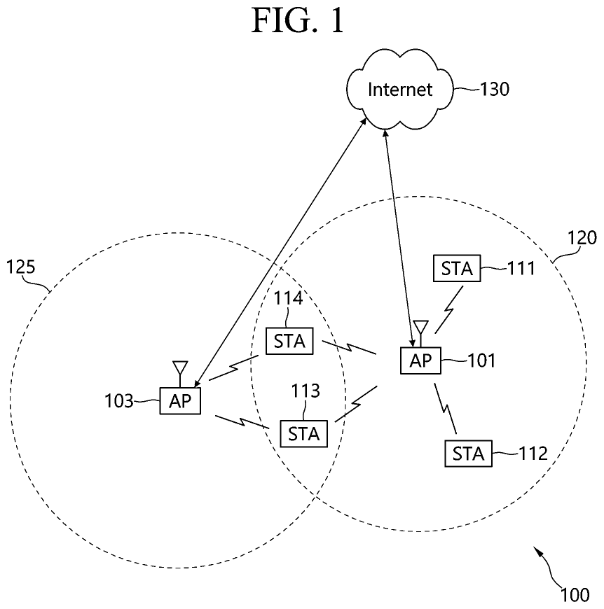

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

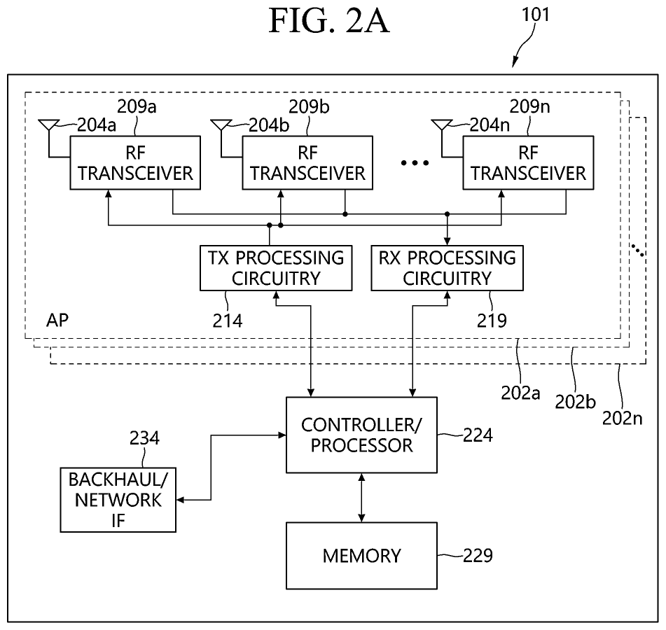

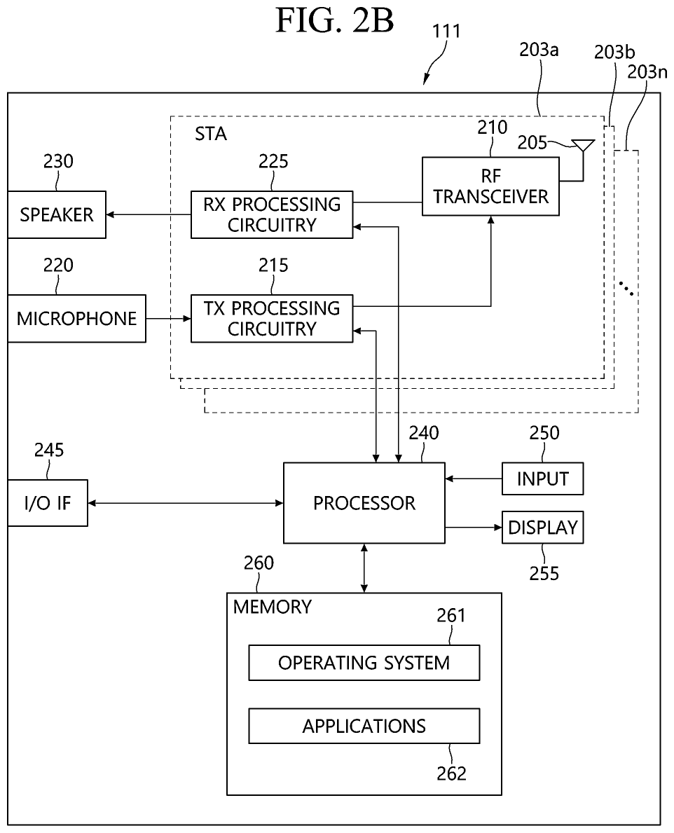

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

Embodiments in accordance with this disclosure may increase the range of wireless connectivity of an access point (AP) so that users can get connectivity in areas where the AP signal is weak/not available. In some embodiments, a relay can be used for supporting this functionality. A relay can act as an intermediate node that can forward packets received from the AP to the non-AP. An example scenario for use of relay can be that of a smart home where there can be a number of devices such as TV, tablets, etc. that have wireless communications support. These devices can act as relays to enhance the range of the access point.

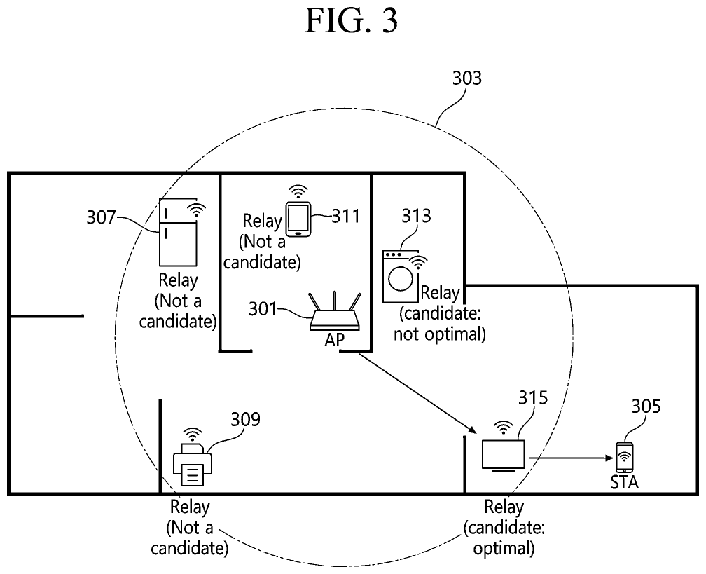

FIG. 3 illustrates an example of a relay in a home environment in accordance with an embodiment. As illustrated, the AP's 301 range is shown by the dotted circle 303. When a user steps outside this circle 303, the user's device, STA 305, may get a poor connection or the connection may be unavailable. A relay can act as an intermediate node and forward the user's traffic so that even when the user is in weak connection areas, it can continue to receive wireless connectivity. As illustrated, the environment includes several devices 307, 309, 311, and 313, and 315. As illustrated, devices 307, 309, and 311 are indicated as not being candidates for a relay. As illustrated, device 313 is indicated as a candidate for a relay and device 315 is indicated as the optimal candidate for the relay between the AP 301 and user's STA 305.

In some embodiments, the user can be inside the AP's range but there can be a transmit power asymmetry. For example, due to power constraints, the user's device can be transmitting at lower power compared to the AP (which can be wall powered and hence can transmit at higher power). Consequently, the user can be able to hear the AP's transmission. However, on the uplink, the AP may not be able to hear the user's transmission. Accordingly, a relay can be useful in such scenarios as well.

Embodiments in accordance with this disclosure may provide a discovery procedure for relay operations. In some embodiments, the discovery procedure can enable the user's device to discover nearby relays and connect to them. In the example in FIG. 3, the discovery procedure should be able to provide the STA 305 with necessary information to enable identification of the candidate relay 315.

Some embodiments may provide latency reduction for relay operation. In particular, if an STA chooses to communicate with an AP via a relay, the total delay can increase due to the multi-hop nature of relay transmissions. For serving low latency traffic, relay operations can benefit from efficient channel access and transmission procedures that result in lower delays.

Some embodiments may provide relay operations with a legacy AP. In particular, when an STA seeks range extension support from a relay, it may be possible that the AP that the STA is communicating or wants to communicate with is a legacy AP. Accordingly, embodiments in accordance with this disclosure may provide for relay operations that can work with legacy APs.

### Relay Discovery

In some embodiments, a relay can be any of variety of different types of devices. For example, a relay can be a mobile AP MLD, a non-AP MLD (e.g., P2P, a normal end device, among others), another AP MLD, among others. Embodiments in accordance with this disclosure may be applicable for both MLO as well as non-MLO operation.

As described herein, a user's end device that uses relay functionalities to connect to its associated AP may be referred to as a STA. The AP that the destination STA (hereby referred to as the STA) intends to connect to via relay can be referred to as a root AP.

In some embodiments, a discovery procedure can be designed to enable end devices to find and connect to a relay. The relay can advertise its presence on its own.

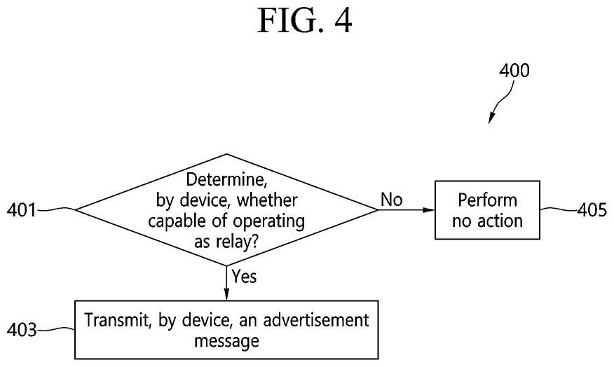

FIG. 4 illustrates a flow chart of an example advertisement procedure in accordance with an embodiment. In operation 401, the device can determine whether it is capable of operating as a relay. If the device determines that it can operate as a relay, then in operation 403, the device can transmit an advertisement message. If the device determines that it cannot operate as a relay, then in operation 405, the device can perform no action.

In some embodiments, the relay can transmit a message for advertisement that can include at least one or more of the information items listed in Table 1.

TABLE 1

| Information | |
|---|---|
| items | Description |
| Relay identifier | An information item that can describe the relay. E.g., |
| | relay's MAC address. |
| Relay | An information item that can describe that the device |
| capability | is capable of acting as a relay. E.g., this can be |
| identifier | a field (e.g., a bit) that can take a predetermined |
| | value (e.g., 1) to make the indication. When the |
| | device can no longer serve as a relay, this field can |
| | take a different value (e.g., 0). |
| Root AP | An information item that can describe the possible |
| possibilities | root APs to which the relay can help an end device |
| | to connect to. E.g., this can be a list of AP's |
| | identifiers such as MAC address, BSSID, etc. |
| Root AP | An information item that can describe the link(s) |
| communication | on which the relay can receive frames from/transmit |
| link | frames to the root AP |
| information | |
| STA | An information item that can describe the link(s) |
| communication | on which the relay can receive frame from/transmit |
| link | frames to the end device. This can be the same set |
| information | of links as those used for communication with the |
| | AP and can be indicated together with the above |
| | information item. |
| Relay | An information item that can describe the capability |
| capability | of the relay node. E.g., supported data rates for |
| | transmission to and from the end device and for |
| | transmission to and from the AP, queuing delays at |
| | the relay, transmit power level constraints, features |
| | supported (e.g., rTWT), etc. |
| Relay type | An information item that can indicate the type of |
| | the relay. E.g., if this is an amplify and forward |
| | relay or a decode and forward relay. |
| Relay device | An information item that can describe the maximum |
| limit | number of nodes that the relay can support if such |
| | a limit exists for the relay. E.g., relay can |
| | consider its own power save and QoS constraints |
| | and determine how many STAs it can serve. |
| Relay per | An information item that can describe the maximum |
| device load | amount of traffic load that the relay can support |
| limit | per device. |
| Service pause | An information item that can describe if the |
| | device has temporarily paused its relay services. |
| AP signal | An information item that can describe the received |
| strength | signal strength of the AP at the relay. This can |
| | enable the STA to choose the relay that has the |
| | strongest signal strength from the AP. E.g., RSSI, |
| | SNR, SINR, etc. |
| Relay signal | An information item that can describe the received |
| strength | signal strength of the relay at the AP. This can |
| | enable the STA to choose the relay that has the |
| | strongest signal strength at the AP. E.g., RSSI, |
| | SNR, SINR, etc. |
| AP and relay | An information item that can indicate an estimate |
| communication | of the communication rate for the path between |
| speed | the relay and the AP (e.g., net rate, downlink |
| information | rate, uplink rate, etc.). For instance, this |
| | can be an estimate of the communication rate |
| | for AP to relay path that the STA can get |
| | if it communicates via the relay. |
| | The relay can take into account the actual |
| | communication rate and if it is currently using |
| | the link for other traffic (e.g., relay's |
| | own traffic, traffic of relay's BSS if relay is |
| | a Mobile AP/AP, traffic of other STAs which the |
| | relay is serving, etc.) it can estimate how much |
| | communication rate can be experienced by a new |
| | STA when it starts to communicate via the relay. |
| | The relay can update this rate each time an STA |
| | joins the relay. For MLO operation, this can be |
| | either a per link estimate and/or an aggregate |
| | estimate. |
| Relay and STA | An information item that can indicate the relay |
| communication | to STA communication rate for the path between |
| speed | the relay and the STA (e.g., net rate, downlink |
| information | rate, uplink rate, etc.). For instance, this |
| | can be an estimate of the communication rate |
| | for relay to STA path that the STA can get if it |
| | communicates via the relay. The relay can take |
| | into account the actual communication rate |
| | and if it is currently using the link for other |
| | traffic (e.g., relay's own traffic, traffic |
| | of relay's BSS if relay is a Mobile AP/AP, |
| | traffic of other STAs which the relay is serving, |
| | etc.) it can estimate how much communication |
| | rate can be experienced by a new STA when it |
| | starts to communicate via the relay. The |
| | relay can update this rate each time an STA |
| | joins the relay. For MLO operation, this can be |
| | either a per link estimate and/or an aggregate |
| | estimate. |
| End to end | An information item that can indicate the end |
| communication | to end communication rate that STA can get if |
| speed | it communicates via the relay. For instance, |
| information | the relay can provide this information based |
| | on a reference STA (the reference STA's |
| | signal strength to the relay, bandwidth, etc. |
| | can be either a pre-known value based on the |
| | spec or can be separately advertised by the |
| | relay as an additional information item). |
| | For MLO operation, this can be either a per |
| | link estimate and/or an aggregate estimate. |
| Channel | An information item that can describe the |
| statistics | channel statistics such as CCA, channel |
| | utilization, idle time, etc. This can also |
| | be per link and can be advertised either on |
| | the same link and/or in a cross link manner. |
| | This information can be for the path between |
| | the relay and the AP and/or the path between |
| | the relay and the STA. |
| Resource | An information item that can describe any |
| constraints | kind of resource constraints such as the |
| | buffer capacity that the relay has or can |
| | use for relay operation. E.g., if the relay |
| | has hardware limitations and can dedicate |
| | only a certain portion of its buffer |
| | capacity for buffering relayed traffic, then |
| | it can make this advertisement. This |
| | information can comprise any description of |
| | buffer configuration, buffer sizes, buffer |
| | characteristics, buffer management policies |
| | for certain traffic types, etc. This can be |
| | useful for the STA to choose a relay based |
| | on its buffer capacity and one that is suited |
| | to its own traffic characteristics. E.g., |
| | if the STA has a bulk download that will |
| | have bursty traffic with large burst lengths, |
| | then this information can help it choose a |
| | relay that can provide a bigger buffer for |
| | relay operations. On the other hand, if the |
| | STA's traffic is not going to require big |
| | buffer sizes, then it can choose a relay that |
| | can provide a smaller buffer size. |
| Transmit power | An information item that can describe the |
| information | transmit power information for the relay. |
| | E.g., the relay can advertise the transmit |
| | power per link/transmit power configuration |
| | per link. |

In some embodiments, the above indicated advertisement message can be transmitted via one or more frames/elements/fields/subfields. These frames/elements/fields/subfields can be newly defined ones or any of those existing in the standards. For instance, if the relay is a mobile AP/AP it can transmit the above advertisement message in its management frames such as beacons, probe responses, among others.

In some embodiments, when a device can perform relay functionalities, it can transmit the advertisement message. When a device can no longer perform relay functionalities (e.g., due to overload or power save constraints), it can stop making such an advertisement or can make an indication of a temporary pause. When a device resumes its functionalities, it can start to advertise again. When any device hears the relay's advertisement, it can discover the relay and connect to it.

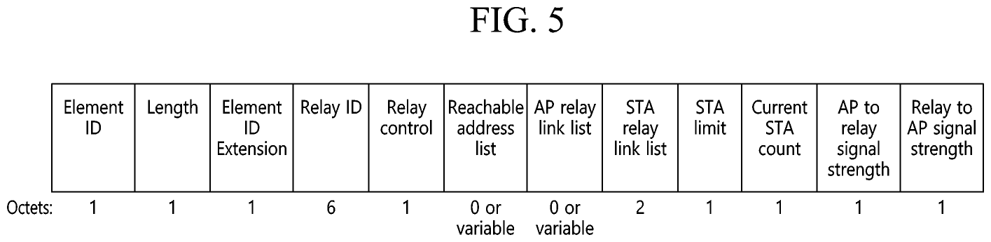

FIG. 5 illustrates a relay advertisement element in accordance with an embodiment. An advertisement message can be transmitted in the form of an advertisement element. The element can take a format as shown in FIG. 5. The element can include an element ID field, a length field, an element ID extension field, a relay ID field, a relay control field, a reachable address list field, an AP relay link list field, an STA relay link list field, an STA limit field, a current STA count field, an AP to relay signal strength field, and a relay to AP signal strength field.

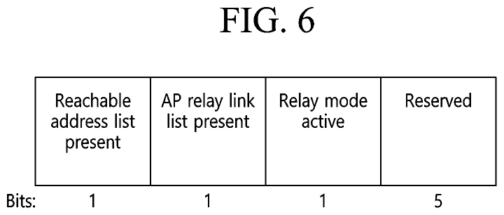

The element ID field can provide identification information of the element. The length field can provide length information of the element. The element ID extension field can provide an identifier extension for the element. The relay ID field can indicate the MAC address of the device that can act as a relay. The relay control field can provide relay control information and can have a format as shown in FIG. 6 described below.

The reachable address list field can indicate the MAC addresses of the APs and/or STAs that can be reached through the relay. In case the AP decides to relay the traffic of an STA through the particular relay, the AP can understand if the relay can reach out to the STA or not. In case the STA decides to use relay for relay operations, this field can enable the STA to understand if a particular relay can help with relay operations for its AP or not.

The AP relay link list can provide a link ID bitmap for each of the APs listed in the reachable address list in the same order in which they are listed. Each link ID bitmap can provide an indication of the link(s) that the relay can use to communicate with that particular AP and/or STA. A value of 1 in the bit position i of this bitmap can indicate to the receiver that the transmitter of this element can perform relay operations on the link with link ID equal to i when communicating with the particular AP. A value of 0 in the bit position i, of this bitmap can indicate to the receiver that the transmitter cannot perform relay operations on the link with link ID equal to i when communicating with the particular AP. In certain embodiments, this can be a single bitmap indicating all the link(s) that can be used for communication between the AP and the relay.

The STA relay link list can be a link ID bitmap. A value of 1 in the bit position i of this bitmap can indicate to the receiver that the transmitter of this element can perform relay operations on the link with link ID equal to i. A value of 0 in the bit position i, of this bitmap can indicate to the receiver that the transmitter cannot perform relay operations on the link with link ID equal to i.

The STA limit field can indicate the maximum number of STAs that the relay can serve at a time. The current STA count field can indicate the number of STAs that the relay is currently serving. This field combined with the STA limit field can indicate to the receiver the number of additional STAs that the relay can handle.

The AP to relay signal strength field can indicate the signal strength (e.g., received signal strength indicator (RSSI) values, among others) for the received signal from the AP at the relay. The relay to AP signal strength field can indicate the signal strength (e.g., RSSI values, among others) for the receive signal from the relay at the AP. This field can be obtained by the relay by performing measurements with the AP. If the values are not available, the field can be set to a predetermined reserved value.

FIG. 6 illustrates a relay control field format in accordance with an embodiment. The reachable address list present subfield can be set to 1 to indicate that the reachable address list field is present in the relay advertisement element. If not present, this bit can be set to 0.

The AP relay link list present field can be set to 1 to indicate that the AP relay link list field in FIG. 5 is present. If not present, this bit can be set to 0. The relay mode active bit field can be set to 1 if the transmitting device is in relay mode and can perform relay operations at the time of transmitting the element. If not, this bit can be set to 0. The reserved field may be reserved.

In some embodiments, if the relay is a Mobile AP/AP, the relay can include the above element in management frames such as beacons, probe responses, among other types of frames that it transmits. In some embodiments, an AP can advertise the possible relays that exist in its network.

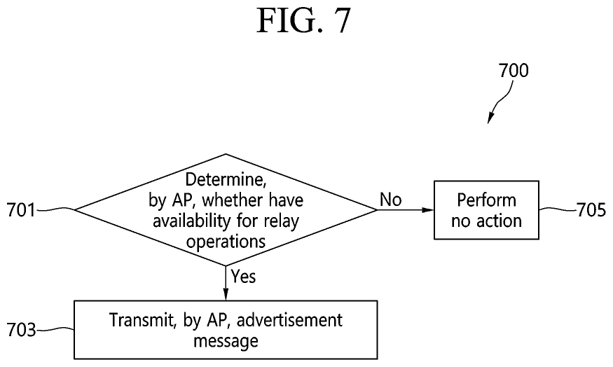

FIG. 7 illustrates a flowchart of an AP side advertisement procedure in accordance with an embodiment. As illustrated, the process 700 in operation 701, the AP determines whether it has availability for relay operations. If the AP determines that it has relay availability, then in operation 703, the AP transmits an advertisement message. If in operation 701, the AP determines that it does not have availability for relay operations, then in operation 705 the AP performs no action.

In some embodiments, the relay availability information can be useful for a number of reasons. For instance, it can enable an STA to find an AP that provides range extension capabilities and give preference to such APs during association. In another example, it can enable an STA to connect to a relay ahead of time to ensure that there are no setup delays when it needs range extension capabilities.

In some embodiments, the AP can transmit a message to its associated STAs to advertise the relays that can be used to connect to the AP when needed. The relay advertisement message can include at least one or more of the information items as described in Table 2.

TABLE 2

| Information | |
|---|---|
| items | Description |
| Relay list | An information item that can describe the list of |
| | relays that can be used to connect to the AP. E.g., |
| | this can be a list of MAC addresses of the relays |
| | or any kind of relay identifiers. |
| Relay | An information item that can describe the capabilities |
| capabilities | of the relay. E.g., any of the capability related |
| | information items described in Table 1. |
| Relay signal | An information item that can describe the received |
| strength | signal strength from the relay at the AP side. This |
| | can enable to choose the relay with the strongest |
| | signal strength at the AP side. E.g., SNR, SINR, |
| | RSSI, etc. |
| AP signal | An information item that can describe the received |
| strength | signal strength of the AP at the relay side. This |
| | can enable to choose the relay with the strongest |
| | signal strength from the AP. E.g., SNR, SINR, RSSI, |
| | etc. |
| Link | An information item that can describe the link(s) |
| information | that the AP can use for communication with a given |
| | relay or any relay in general. |
| Link limit | An information item that can describe the limit |
| | on the number of links that the AP can use to |
| | communicate with a given relay or any relay in |
| | general. For instance, due to resource limitations |
| | on the AP side, the AP may not be able to use all |
| | the links for communication with a relay or any |
| | relay in general. |
| STA limit | An information item that can describe the limit |
| | on the maximum number of STAs that the AP can |
| | serve via the relay. |
| Current STA | An information item that can describe the total |
| count | number of STAs that the AP is currently serving |
| | via the relay. |
| Channel | An information item that can describe the |
| statistics | channel statistics on the relay side. E.g., CCA, |
| | channel utilization, idle time information, etc. |
| | This can enable the STA to choose a relay that |
| | can provide it with the highest end to end |
| | communication speed. If the AP advertises more |
| | than one relay, then this information can be |
| | provided per relay. |
| AP and relay | An information item that can indicate an estimate |
| communication | of the communication rate for the path between |
| speed | the relay and the AP (e.g., net rate, downlink |
| information | rate, uplink rate, etc.). For instance, this can |
| | be an estimate of the communication rate for AP |
| | to relay path that the STA can get if it |
| | communicates via the relay. This can take into |
| | account the actual communication rate and if |
| | the relay is currently using the link for other |
| | traffic (e.g., relay's own traffic, traffic |
| | of relay's BSS if relay is a Mobile AP/AP, |
| | traffic of other STAs which the relay is serving, |
| | etc.) this can indicate how much communication |
| | rate can be experienced by a new STA when it |
| | starts to communicate via the relay. This |
| | information item can be updated each time an |
| | STA joins the relay. For MLO operation, this |
| | can be either a per link estimate and/or an |
| | aggregate estimate. |
| Relay and STA | An information item that can indicate the |
| communication | relay to STA communication rate for the path |
| speed | between the relay and the STA (e.g., net rate, |
| information | downlink rate, uplink rate, etc.). For |
| | instance, this can be an estimate of the |
| | communication rate for relay to STA path that |
| | the STA can get if it communicates via the |
| | relay. This parameter can take into account the |
| | actual communication rate and if the relay is |
| | currently using the link for other traffic |
| | (e.g., relay's own traffic, traffic of |
| | relay's BSS if relay is a Mobile AP/AP, |
| | traffic of other STAs which the relay is |
| | serving, etc.) this can estimate how much |
| | communication rate can be experienced by a |
| | new STA when it starts to communicate via the |
| | relay. This information item can be updated |
| | each time an STA joins the relay. For MLO |
| | operation, this can be either a per link |
| | estimate and/or an aggregate estimate. |
| End to end | An information item that can indicate the |
| communication | end to end communication rate that STA |
| speed | can get if it communicates via the relay. |
| information | For instance, the relay can provide this |
| | information based on a reference STA (the |
| | reference STA's signal strength to the |
| | relay, bandwidth, etc. can be either a pre- |
| | known value based on the spec or can be |
| | separately advertised by the relay as an |
| | additional information item). For MLO |
| | operation, this can be either a per link |
| | estimate and/or an aggregate estimate. The |
| | information obtained from the relay can be |
| | advertised. |
| Resource | An information item that can describe any |
| constraints | kind of resource constraints such as the |
| | buffer capacity that the relay has or can |
| | use for relay operation. E.g., if the relay |
| | has hardware limitations and can dedicate |
| | only a certain portion of its buffer |
| | capacity for buffering relayed traffic, |
| | then it can make this advertisement. This |
| | information can comprise any description |
| | of buffer configuration, buffer sizes, |
| | buffer characteristics, buffer management |
| | policies for certain traffic types, etc. |
| | This can be useful for the STA to choose |
| | a relay based on its buffer capacity and |
| | one that is suited to its own traffic |
| | characteristics. E.g., if the STA has a |
| | bulk download that will have bursty |
| | traffic with large burst lengths, then |
| | this information can help it choose a |
| | relay that can provide a bigger buffer |
| | for relay operations. On the other hand, if |
| | the STA's traffic is not going to require |
| | big buffer sizes, then it can choose a relay |
| | that can provide a smaller buffer size. |
| Transmit power | An information item that can describe the |
| information | transmit power information for |
| | the relay. E.g., this can be the advertised |
| | transmit power per link/transmit power |
| | configuration per link. |
| Multi-hop | An information item that can describe if the |
| capabilities | AP can support single or multi-hop relay |
| | functionality. |

The above indicated message can be transmitted via one or more frames/elements/fields/subfields. These frames/elements/fields/subfields can be newly defined ones or any of those existing in the standard. For instance, if the root AP is a Mobile AP/AP it can transmit the above advertisement message in its management frames such as beacons, probe responses, among others.

In some embodiments, upon receiving such a message from the root AP, the STA can understand the devices that can act as a relay for the root AP. The STA can set up relay connection with those relays in advance. In some embodiments, the advertisement information can be transmitted in an element.

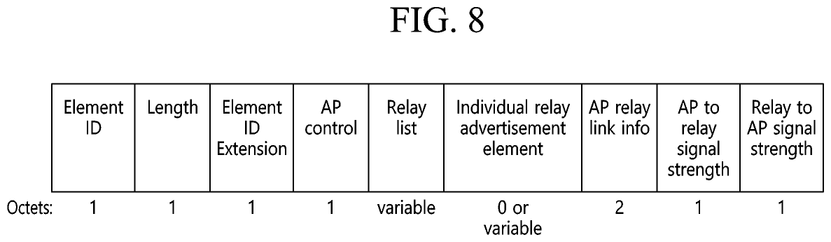

FIG. 8 illustrates an advertisement element format in accordance with an embodiment. The advertisement element may include an element ID field, a length field, an element ID extension field, an AP control field, a relay list field, an individual relay advertisement element field, an AP relay link info field, an AP to relay signal strength field, and a relay to AP signal strength field.

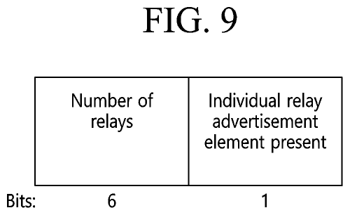

The element ID field can provide identification information of the element. The length field can provide length information of the element. The element ID extension field can provide an identifier extension for the element. The AP control field can include control information and have a format as shown in FIG. 9. The relay list field can be a list of relays that the AP can relay its traffic through. The individual relay advertisement element can provide relay advertisement information.

The AP relay link info field can be a link ID bitmap that can indicate the links that the AP can use to communicate with the relay. A value of 1 in the bit position i of this bitmap can indicate to the receiver that the AP can perform relay operations on the link with link ID equal to i. A value of 0 in the bit position i, of this bitmap can indicate to the receiver that the AP cannot perform relay operations on the link with link ID equal to i. The AP to relay signal strength field can indicate the signal strength (e.g., RSSI values) for the received signal from the AP at the relay.

The relay to AP signal strength field can indicate the signal strength (e.g., RSSI values) for the receive signal from the relay at the AP. This field can be obtained by the relay by performing measurements with the AP. If the values are not available, the field can be set to a predetermined reserved value. The information about the relay can be obtained in various ways (individually used or used together) as described below.

FIG. 9 illustrates an AP control field format in accordance with an embodiment. The number of relays field can indicate the total number of relays that are present in the relay list. The individual relay advertisement element present bit can be set to 1 if the relay advertisement elements from relays that can serve this AP are present in the individual relay advertisement element list in FIG. 8.

Some embodiments may provide for a query-based search. In some embodiments, an AP can transmit a query message to devices in its range to check if they can provide relay functionalities to it.

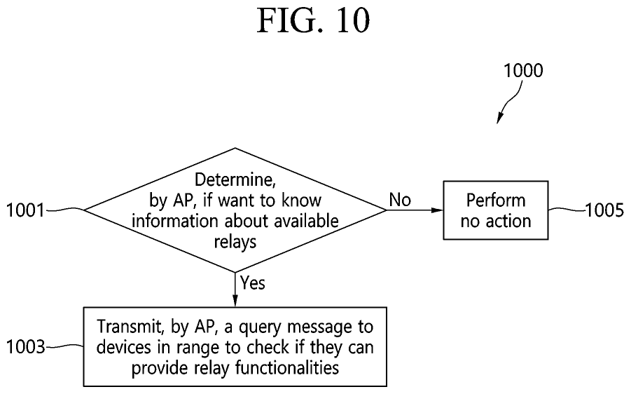

FIG. 10 illustrates a flowchart of an example process of an AP side query based search in accordance with an embodiment. The process 1000, in operation 1001, the AP determines whether it wants to know information about available relays. If in operation 1001, the AP determines that it does want to know information about available relays, then in operation 1003 the AP transmits a query message to devices in range to check if they can provide relay functionalities. If in operation 1001, the AP determines that it does not want to know information about available relays, then in operation 1005 the AP performs no action.

In some embodiments, the query message can include at least one or more of the information items as described in Table 3.

TABLE 3

| Information item | Description |
|---|---|
| Relay availability | An information item to check for the availability of |
| | the relay. |
| Relay duration | An information item that can describe the duration |
| | from which the relay services can be needed. |
| Relay start time | An information item that can describe the start time |
| | of relay operation. |
| Relay link | An information item that can describe the link(s) |
| information | on which the relay operation is desired. |
| STA information | An information item that can describe the STAs for |
| | which the relay support is needed. This can |
| | enable the relay to check if it can serve as a |
| | relay for the STA or not E.g., if the relay is |
| | not in the communication range of the STA, then |
| | it can refuse to provide relay functionalities. |
| | This information can also enable the relay |
| | to estimate the communication speed to |
| | the STA and verify if it can meet the STA's |
| | needs or not prior to agreeing to serve as a |
| | relay. |
| Expected relay | An information item that can describe the |
| performance | performance that is expected from the relay. For |
| | instance, this can be the expected downlink and/or |
| | uplink rates for communication with the AP and/or |
| | the downlink and/or uplink rates for communication |
| | with the STA, the target latency that is needed |
| | for the STA's traffic, the target throughput, |
| | QoS requirements, etc. |
| Expected | An information item that can describe the |
| communication | expected communication rate that needs to be |
| speed | supported if the relay participates in relay |
| | operation. |
| Expected transmit | An information item that can describe the expected |
| power information | transmit power/transmit power configuration if the |
| | relay provides relay services. |
| Traffic | An information item that can describe the traffic |
| characteristics | characteristics of the traffic that the relay |
| | can be expected to handle if it agrees to serve |
| | as a relay. This information can enable the |
| | relay to verify if it can meet the STA's |
| | requirements. E.g., if the relay has some buffer |
| | constraints then it can use this information |
| | to verify if it can handle the traffic of the |
| | STA with its buffer constraints or not. |
| Traffic direction | An information item that can describe the |
| | direction of the traffic. E.g., if the relay |
| | operation can be used for downlink traffic |
| | and/or uplink traffic. |

The above indicated message can be transmitted via one or more frames/elements/fields/subfields. These frames/elements/fields/subfields can be newly defined ones or any of those existing in the standard. Some examples are provided below. In some embodiments, the query message can be transmitted via an element.

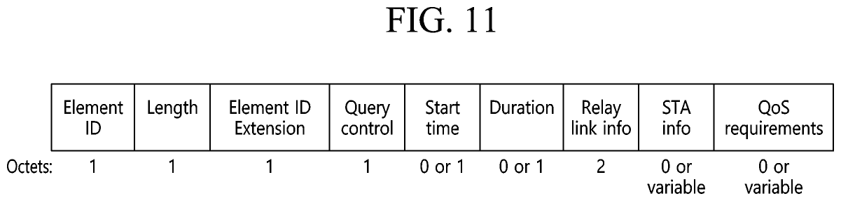

FIG. 11 illustrates an element format for query transmission in accordance with an embodiment. The element may include an element ID field, a length field, an element ID extension field, a query control field, a start time field, a duration field, a relay link info filed, a STA info field, and a QoS requirements field.

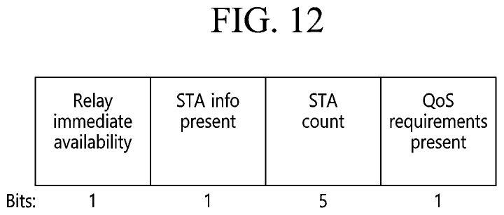

The element ID field can provide identification information of the element. The length field can provide length information of the element. The element ID extension field can provide an identifier extension for the element. The query control field can provide control information and can have a format as shown in FIG. 12. The start time field can indicate the time when the delay operation can be needed. The duration field can indicate the duration for which the relay operation can be needed.

The relay link info field can be a link ID bitmap which can indicate the link(s) on which the relay operation can be needed. A value of 1 in the bit position i of this bitmap can indicate to the receiver that the transmitter needs relay operations on the link with link ID equal to i. A value of 0 in the bit position i, of this bitmap can indicate to the receiver that the transmitter does not need relay operations on the link with link ID equal to i.

The STA info field can include the information about the STAs for whom the relay operation can be needed. In some embodiments, the STA info field can include the MAC address of the STAs. If the relay operation is not needed for a specific STA but the transmitter wants to know the availability of the receiver for relay operations in general, this field can be skipped.

The QoS requirements field can include the QoS requirements for each of the STA for whom the relay operation is needed. In some embodiments, this can be the QoS characteristic information element for each STA to indicate their QoS requirements during relay operation.

FIG. 12 illustrates a query control field format in accordance with an embodiment. The query control field format can include a relay immediate availability filed, a STA info present field, a STA count field, and a QoS requirements present field.

The relay immediate availability bit field can be set to 1 if the transmitter expects the receiver to be immediately available for relay operations. If relay's immediate availability is not required, then the transmitter can insert a start time and duration field to indicate when the relay support is needed.

The STA info present bit field can be set to 1 if the STA info field in FIG. 11 is present. Otherwise, it can be set to 0. The STA count field can be set to a number that is equal to the number of STA whose info is present in the STA info field. If STA info field is not present, this field can be set to 0. The QoS requirements present field can be set to 1 if the QoS requirements field is present. Otherwise, it can be set to 0.

In some embodiments, the query message can be transmitted via a control frame.

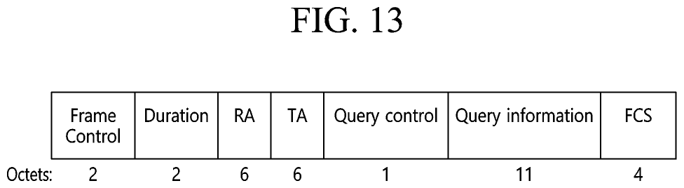

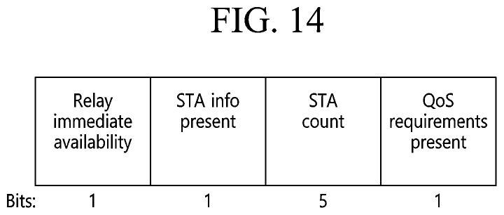

FIG. 13 illustrates a control frame format for query message in accordance with an embodiment. The control frame format can include a frame control field, a duration field, a receiver address (RA) field, a transmitter address (TA) field, a query control field, a query information field, and a frame check sequence (FCS) field. The frame control field can include frame control information. The duration field can include duration information. The RA field can provide receiver address information. The TA field can include transmitter address information. The query control field can include control information and can have a format as shown in FIG. 14.

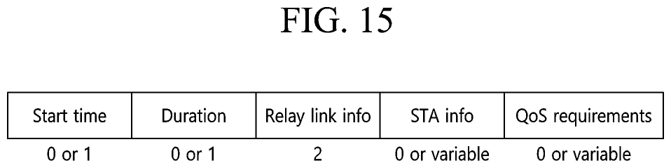

The query information field can include query information and can have a format as shown in FIG. 15. The FCS field can provide information for error detection.

FIG. 14 illustrates a query control field format in accordance with an embodiment. The subfields in FIG. 14 can have the same and/or similar format as those in FIG. 12. In particular, the query control field format can include a relay immediate availability filed, a STA info present field, a STA count field, and a QoS requirements present field.

The relay immediate availability bit field can be set to 1 if the transmitter expects the receiver to be immediately available for relay operations. If relay's immediate availability is not required, then the transmitter can insert a start time and duration field to indicate when the relay support is needed. The STA info present bit field can be set to 1 if the STA info field in FIG. 11 is present. Otherwise, it can be set to 0. The STA count field can be set to a number that is equal to the number of STA whose info is present in the STA info field. If STA info field is not present, this field can be set to 0. The QoS requirements present field can be set to 1 if the QoS requirements field is present. Otherwise, it can be set to 0.

FIG. 15 illustrates a query information field format in accordance with an embodiment. The subfields in FIG. 15 can have the same or similar format as those in FIG. 11. In particular, the query information field format can include a start time filed, a duration field, a relay link info field, a STA info field and a QoS requirements field. The start time field can indicate the time when the delay operation can be needed. The duration field can indicate the duration for which the relay operation can be needed.

The relay link info field can be a link ID bitmap which can indicate the link(s) on which the relay operation can be needed. A value of 1 in the bit position i of this bitmap can indicate to the receiver that the transmitter needs relay operations on the link with link ID equal to i. A value of 0 in the bit position i, of this bitmap can indicate to the receiver that the transmitter does not need relay operations on the link with link ID equal to i.

The STA info field can include the information about the STAs for whom the relay operation can be needed. In some embodiments, the STA info field can include the MAC address of the STAs. If the relay operation is not needed for a specific STA but the transmitter wants to know the availability of the receiver for relay operations in general, this field can be skipped.

The QoS requirements field can include the QoS requirements for each of the STA for whom the relay operation is needed. In some embodiments, this can be the QoS characteristic information element for each STA to indicate their QoS requirements during relay operation.

In some embodiments, the query message can be transmitted in an action frame. The action frame can have a format as shown in Table 4

TABLE 4

| Order | Information |
|---|---|
| 1 | Category |
| 2 | Protected Action |
| 3 | Dialog Token |
| 4 | Query element |

The category field may indicate the category of the action frame. The protected action field may enable differentiating the protected action frame formats. The dialog token can be a non-zero value that can be chosen by the requesting entity of the frame to identify the request/response transaction. The request element can have a format as shown in FIG. 11.

In some embodiments, the query message can be carried in a control subfield variant of an A-control subfield.

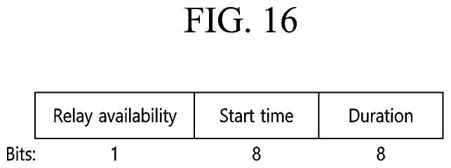

FIG. 16 illustrates an A-control subfield format in accordance with an embodiment. The relay availability bit field can be set to 1 to indicate that the transmitter needs the relay operation immediately. If the relay availability is not needed immediately, then the transmitter can set this bit to 0. The start time field can indicate the time at which the relay operation can start. The duration field can indicate the duration for which the relay operation can last.

Upon receiving the message from the AP, the relay can transmit a response message that includes at least one or more of the information items as described in Table 5 and FIG. 13.

TABLE 5

| Information | |
|---|---|
| items | Description |
| Relay identifier | An information item that can describe the relay. E.g., |
| | relay's MAC address. |
| Relay | An information item that can describe that the device |
| capability | is capable of acting as a relay. E.g., this can be |
| identifier | a field (e.g., a bit) that can take a predetermined |
| | value (e.g., 1) to make the indication. When the |
| | device can no longer serve as a relay, this field |
| | can take a different value (e.g., 0). |
| Root AP | An information item that can describe the possible |
| possibilities | root APs to which the relay can help an end device |
| | to connect to. E.g., this can be a list of AP's |
| | identifiers such as MAC address, BSSID, etc. |
| Root AP | An information item that can describe the link(s) |
| communication | on which the relay can receive frames from/transmit |
| link information | frames to the root AP |
| STA | An information item that can describe the link(s) on |
| communication | which the relay can receive frame from/transmit |
| link | frames to the end device. This can be the same set |
| information | of links as those used for communication with the |
| | AP and can be indicated together with the above |
| | information item. |
| Relay | An information item that can describe the capability |
| capability | of the relay node. E.g., supported data rates for |
| | transmission to and from the end device and for |
| | transmission to and from the AP, queuing delays at |
| | the relay, transmit power level constraints, |
| | features supported (e.g., rTWT), etc. |
| Relay device | An information item that can describe the maximum |
| limit | number of nodes that the relay can support if such |
| | a limit exists for the relay. E.g., relay can |
| | consider its own power save and QoS constraints |
| | and determine how many STAs it can serve. |
| Relay per | An information item that can describe the maximum |
| device load | amount of traffic load that the relay can support |
| limit | per device. |
| Service pause | An information item that can describe if the device |
| | has temporarily paused its relay services. |
| AP signal | An information item that can describe the received |
| strength | signal strength of the AP at the relay. This can |
| | enable the STA to choose the relay that has the |
| | strongest signal strength from the AP. E.g., RSSI, |
| | SNR, SINR, etc. |
| Relay signal | An information item that can describe the received |
| strength | signal strength of the relay at the AP. This can |
| | enable the STA to choose the relay that has the |
| | strongest signal strength at the AP. E.g., RSSI, |
| | SNR, SINR, etc. |
| AP and relay | An information item that can indicate an estimate |
| communication | of the communication rate for the path between |
| speed | the relay and the AP (e.g., net rate, downlink |
| information | rate, uplink rate, etc.). For instance, this can |
| | be an estimate of the communication rate for AP |
| | to relay path that the STA can get if it |
| | communicates via the relay. The relay can take |
| | into account the actual communication rate |
| | and if it is currently using the link for other |
| | traffic (e.g., relay's own traffic, traffic |
| | of relay's BSS if relay is a Mobile AP/AP, |
| | traffic of other STAs which the relay is |
| | serving, etc.) it can estimate how much |
| | communication rate can be experienced by a new |
| | STA when it starts to communicate via the relay. |
| | The relay can update this rate each time an |
| | STA joins the relay. For MLO operation, this |
| | can be either a per link estimate and/or an |
| | aggregate estimate. |
| Relay and STA | An information item that can indicate the relay |
| communication | to STA communication rate for the path between |
| speed | the relay and the STA (e.g., net rate, downlink |
| information | rate, uplink rate, etc.). For instance, this can |
| | be an estimate of the communication rate for relay |
| | to STA path that the STA can get if it communicates |
| | via the relay. The relay can take into account |
| | the actual communication rate and if it is |
| | currently using the link for other traffic (e.g., |
| | relay's own traffic, traffic of relay's |
| | BSS if relay is a Mobile AP/AP, traffic of other |
| | STAs which the relay is serving, etc.) it can |
| | estimate how much communication rate can be |
| | experienced by a new STA when it starts to |
| | communicate via the relay. The relay can update |
| | this rate each time an STA joins the relay. For |
| | MLO operation, this can be either a per link |
| | estimate and/or an aggregate estimate. |
| End to end | An information item that can indicate the end to |
| communication | end communication rate that STA can get if it |
| speed | communicates via the relay. For instance, the |
| information | relay can provide this information based on a |
| | reference STA (the reference STA's signal |
| | strength to the relay, bandwidth, etc. can |
| | be either a pre-known value based on the spec |
| | or can be separately advertised by the relay as |
| | an additional information item). For MLO |
| | operation, this can be either a per link |
| | estimate and/or an aggregate estimate. |
| Channel | An information item that can describe the channel |
| statistics | statistics such as CCA, channel utilization, idle |
| | time, etc. This can also be per link and can be |
| | advertised either on the same link and/or in a |
| | cross link manner. This information can be for |
| | the path between the relay and the AP and/or the |
| | path between the relay and the STA. |
| Resource | An information item that can describe any kind |
| constraints | of resource constraints such as the buffer |
| | capacity that the relay has or can use for relay |
| | operation. E.g., if the relay has hardware |
| | limitations and can dedicate only a certain |
| | portion of its buffer capacity for buffering |
| | relayed traffic, then it can make this |
| | advertisement. This information can comprise any |
| | description of buffer configuration, buffer sizes, |
| | buffer characteristics, buffer management |
| | policies for certain traffic types, etc. This can |
| | be useful for the STA to choose a relay based |
| | on its buffer capacity and one that is suited |
| | to its own traffic characteristics. E.g., if the |
| | STA has a bulk download that will have bursty |
| | traffic with large burst lengths, then this |
| | information can help it choose a relay that can |
| | provide a bigger buffer for relay operations. |
| | On the other hand, if the STA's traffic is |
| | not going to require big buffer sizes, then |
| | it can choose a relay that can provide a |
| | smaller buffer size. |
| Transmit power | An information item that can describe the transmit |
| information | power information for the relay. E.g., the relay |
| | can advertise the transmit power per link/transmit |
| | power configuration per link. |

The above indicated message can be transmitted via one or more frames/elements/fields/subfields. These frames/elements/fields/subfields can be newly defined ones or any of those existing in the standard. Some examples are provided below.

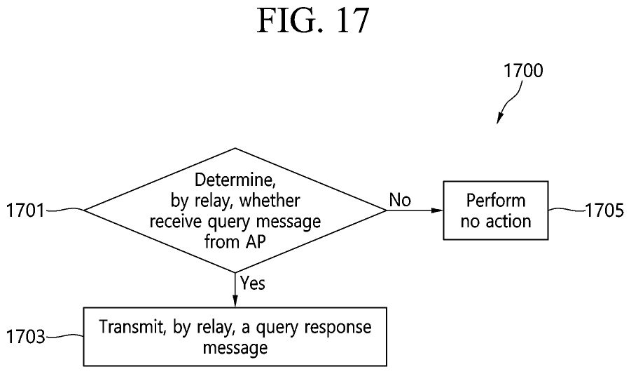

FIG. 17 illustrates a flow chart of a relay side response procedure in accordance with an embodiment. The process 1700 in operation 1701, the relay determines whether it receives a query message from the AP. In operation 1701, if the relay determines that it does receive a query message from the AP, then in operation 1703 the relay transmits a query response. In operation 1701, if the relay determines that it does not receive a query message from the AP, then in operation 1705 the relay performs no action.

In some embodiments, the response message can be transmitted in an element. In some embodiments, the element can have the same or similar format as in FIG. 5.

In some embodiments, the response message can be transmitted in a control frame. The control frame can have a format as shown in FIG. 6.

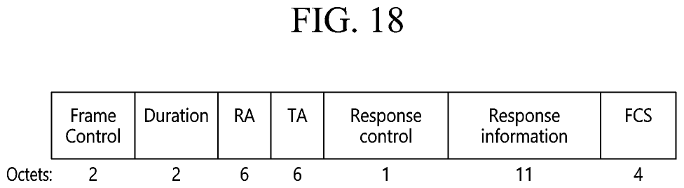

FIG. 18 illustrates a control frame format for response query in accordance with an embodiment. The control frame format can include a frame control field, a duration field, a receiver address (RA) field, a transmitter address (TA) field, a response control field, a response information field, and an FCS field.

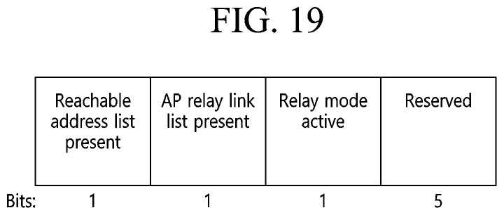

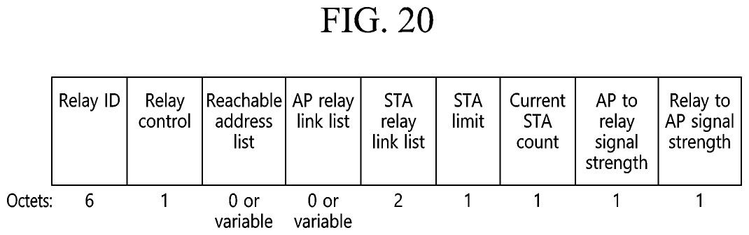

The frame control field can include frame control information. The duration field can include duration information. The RA field can provide receiver address information. The TA field can include transmitter address information. The response control field can include control information and can have a format as illustrated in FIG. 19. The response information field can include response information and can have a format as illustrated in FIG. 20. The FCS field can provide information for error detection.

In some embodiments, the subfields in FIG. 19 and FIG. 20 can have the same format as those in FIG. 6 and FIG. 5. In particular, FIG. 19 illustrates a response control field format in accordance with an embodiment. The response control field format can include a reachable address list present field, a AP relay link present field, a relay mode active field and a reserved field.

The reachable address list present field can be set to 1 to indicate that the reachable address list field is present in the relay element. If not present, this bit can be set to 0. The AP relay link list present field can be set to 1 to indicate that the AP relay link list field in FIG. 5 is present. If not present, this bit can be set to 0. The relay mode active bit field can be set to 1 if the transmitting device is in relay mode and can perform relay operations at the time of transmitting the element. If not, this bit can be set to 0. The reserved field may be reserved.

FIG. 20 illustrates a response information field format in accordance with an embodiment. The response information field format can include a relay ID field, a relay control field, a reachable address list field, an AP relay link list field, a STA relay link list field, a STA limit field, a current STA count field, an AP to relay signal strength field, and a relay to AP signal strength field.

The relay ID field can indicate the MAC address of the device that can act as a relay. The relay control field can provide relay control information and can have a format as shown in FIG. 6.

The reachable address list field can indicate the MAC addresses of the APs and/or STAs that can be reached through the relay. In case the AP decides to relay the traffic of an STA through the particular relay, the AP can understand if the relay can reach out to the STA or not. In case the STA decides to use relay for relay operations, this field can enable the STA to understand if a particular relay can help with relay operations for its AP or not.

The AP relay link list can provide a link ID bitmap for each of the APs listed in the reachable address list in the same order in which they are listed. Each link ID bitmap can provide an indication of the link(s) that the relay can use to communicate with that particular AP and/or STA. A value of 1 in the bit position i of this bitmap can indicate to the receiver that the transmitter of this element can perform relay operations on the link with link ID equal to i when communicating with the particular AP. A value of 0 in the bit position i, of this bitmap can indicate to the receiver that the transmitter cannot perform relay operations on the link with link ID equal to i when communicating with the particular AP. In certain embodiments, this can be a single bitmap indicating all the link(s) that can be used for communication between the AP and the relay.

The STA relay link list can be a link ID bitmap. A value of 1 in the bit position i of this bitmap can indicate to the receiver that the transmitter of this element can perform relay operations on the link with link ID equal to i. A value of 0 in the bit position i, of this bitmap can indicate to the receiver that the transmitter cannot perform relay operations on the link with link ID equal to i.

The STA limit field can indicate the maximum number of STAs that the relay can serve at a time. The current STA count field in can indicate the number of STAs that the relay is currently serving. This field combined with the STA limit field can indicate to the receiver the number of additional STAs that the relay can handle. The AP to relay signal strength field can indicate the signal strength (e.g., received signal strength indicator (RSSI) values, among others) for the received signal from the AP at the relay. The relay to AP signal strength field can indicate the signal strength (e.g., RSSI values, among others) for the receive signal from the relay at the AP. This field can be obtained by the relay by performing measurements with the AP. If the values are not available, the field can be set to a predetermined reserved value.

In some embodiments, the response message can be carried in an action frame. The action frame can have a format as shown in Table 6.

TABLE 6

| Order | Information |
|---|---|
| 1 | Category |
| 2 | Protected Action |
| 3 | Dialog Token |
| 4 | Status code |
| 5 | Response element |

The category field may indicate the category of the action frame. The protected action field can enable to differentiate the protected action frame formats. The dialog token field can be the same value as in the response frame shown in Table 5. The status code field can indicate the status of the request. The response element field can have a format as described in the example above.

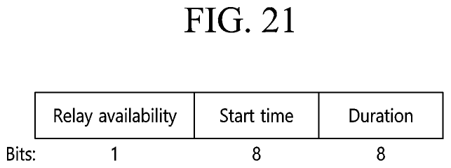

In some embodiments, a control subfield variant of an A-control subfield can be used for carrying the response message. The A-control subfield can have a format as shown in FIG. 21.

FIG. 21 illustrates a format for A-control subfield variant in accordance with an embodiment. The A-control subfield variant can include a relay availability field, a start time field, and a duration field. The relay availability bit field can be set to 1 if the relay is immediately available. It can be set to 0 otherwise. If the relay availability bit is set to 0 and the relay can be available in the future, then the start time field can indicate the time at which the relay can be available and the duration field can indicate the duration for which the relay can be available.

In some embodiments, a query based search can enable an AP to find relays in its vicinity and advertise those relays to its associated STAs.

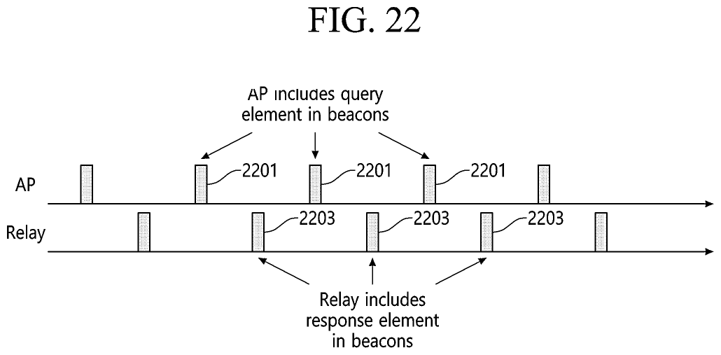

FIG. 22 illustrates an element based request and response operation in accordance with an embodiment. In FIG. 22, suppose that the AP may need to discover the relays in its vicinity. Suppose that a relay in the vicinity is a Mobile AP/another AP. The AP can include the element carrying the query message in its beacons 2201. Upon receiving the query message in the AP's beacons 2201, the Mobile AP/AP can include the response element in beacons 2203 that it transmits as shown in FIG. 22. When the AP receives the element with response message from the relay, it can understand the information corresponding to the relay.

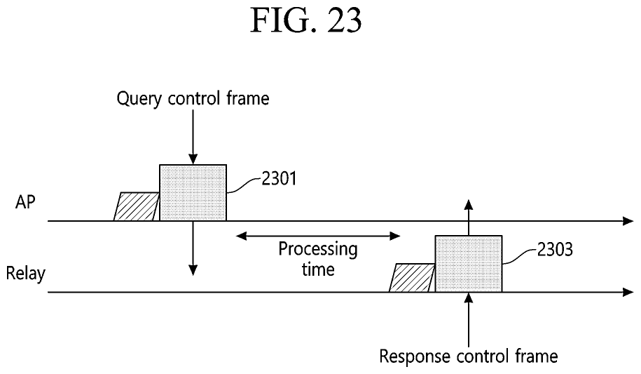

In another example, suppose that the AP needs to know the relay's availability within a short period of time and cannot wait until the beacon transmission. The AP can transmit a query control frame or alternatively an action frame carrying the query element. The relay can process the query and provide a response message in a response control frame. The processing time can also be SIFS duration if the relay can process the query control frame that fast and the response control frame can be transmitted without additional contention. An example is as shown in FIG. 23.

FIG. 23 illustrates a control frame based operation in accordance with an embodiment. In particular, the AP transmits a query control frame 2301 carrying a query element. The relay processes the query and provides a response message in a response control frame 2303.

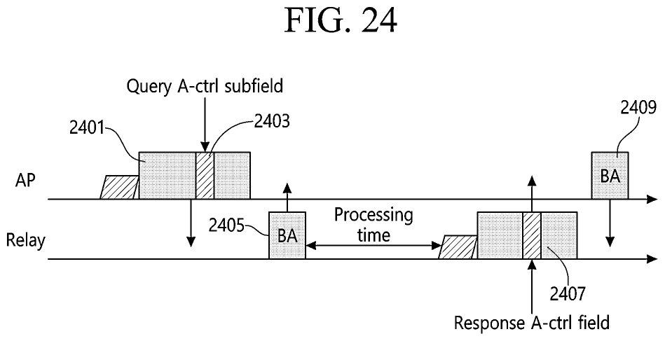

In another example, suppose that the AP is performing a transmission to a non-AP STA that can act as a relay. The AP can include an A-control subfield carrying the query message in its transmission. Upon receiving the information, the non-AP STA can process the query message and transmit a response message in an A-control subfield either in a different frame transmitted to the AP or in a QoS Null frame. An example is as shown in FIG. 24.

FIG. 24 illustrates an A-control subfield operation in accordance with an embodiment. In particular, the AP is performing a transmission 2401 to a non-AP STA. The AP includes an A-control subfield 2403 carrying the query message in its transmission 2401. Upon receiving the information, the non-AP STA can transmit a block acknowledgement (BA) to the AP, process the query message and transmit a response message in an A-control subfield 2407. The AP can transmit a BA to the relay.

Some embodiments may provide passive discovery. In some embodiments, the AP can obtain information about the relay passively via the relay's advertisement. If the AP hears a relay's advertisement message, then it can advertise the relay.

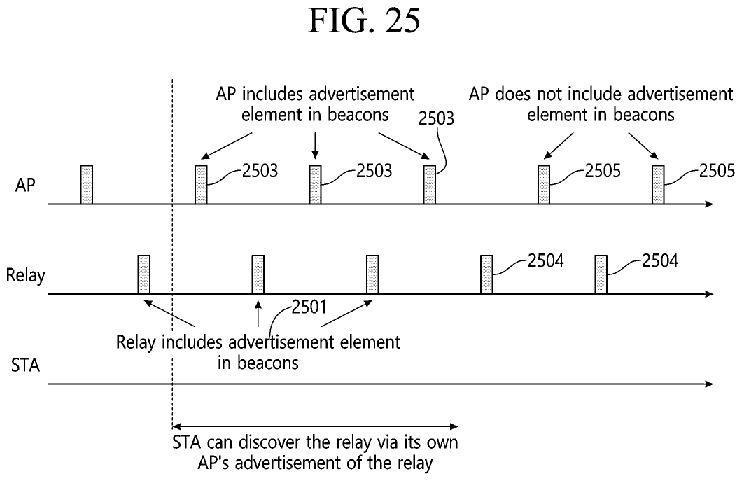

FIG. 25 illustrates passive discovery in accordance with an embodiment. In particular, FIG. 25 illustrates communication between an AP, relay and an STA. As illustrated in FIG. 25, upon becoming available for relay operations, the relay (in this case a Mobile AP/AP) can transmit advertisement element in its own beacons 2501 (advertisement element for relay can have the format as shown in FIG. 5). Upon receiving the advertisement, the AP can verify the relay if necessary and include the relay's information in its own beacons 2503. The relay's information can be included in the advertisement as depicted in FIG. 8. Upon receiving relay information from its own AP, the STA(s) can discover the relay for operation when necessary. Suppose that after some time, the relay is no longer available for relay operations, the relay can stop advertising its information. Consequently, the AP can also stop advertising the relay in its beacons 2505.

In some embodiments, the relay's presence can also be discovered by the AP using the procedures described herein and then the AP can advertise the relay via its beacons. In some embodiments, during the probing procedure or during association, a device that can act as a relay can transmit a message to the AP to inform the AP that it can provide services as a relay. The message can include at least one or more of the information items as indicated in Table 1. The above indicated message can be transmitted via one or more frames/elements/fields/subfields. These frames/elements/fields/subfields can be newly defined ones or any of those existing in the standard.

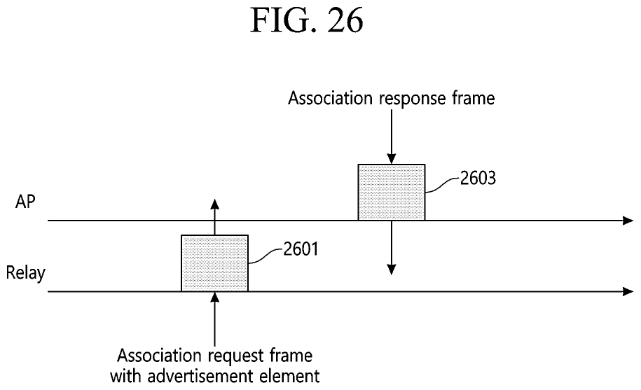

FIG. 26 illustrates an operation using capability advertisement during association in accordance with an embodiment. In particular, a relay transmits an association request frame with an advertisement element 2601 to the AP to inform the AP that the relay can provide services as a relay. The AP transmits an association response frame 2603 to the relay.

In some embodiments, the STA can send a probe message on various channels to check for available relays. A relay that receives the probe message can provide a response message. The probe message transmitted by the STA can include at least one or more of the information items as described in Table 3.

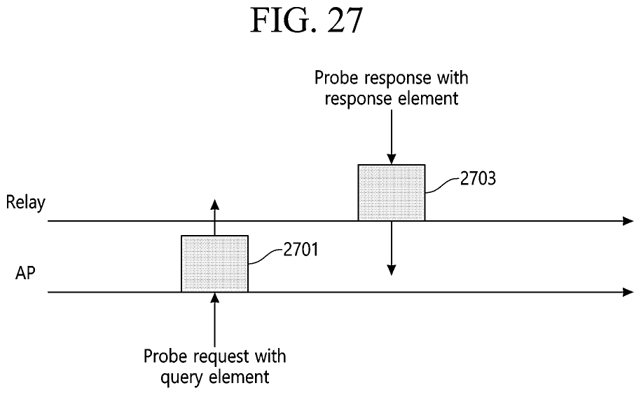

The response message transmitted by the relay can include at least one or more of the information items as described in Table 1. The above indicated messages can be transmitted via one or more frames/elements/fields/subfields. These frames/elements/fields/subfields can be newly defined ones or any of those existing in the standard. An example operation can be as shown in FIG. 27.

FIG. 27 illustrates operation based on STA side probing in accordance with an embodiment. As illustrated, the STA transmits a probe request with a query element 2701 to a relay. The relay transmits a probe response with a response element 2703 to the relay.

In some embodiments, the STA can transmit a relay search request message to its AP. The relay search message can include at least one or more of the information items as described in Table 3.

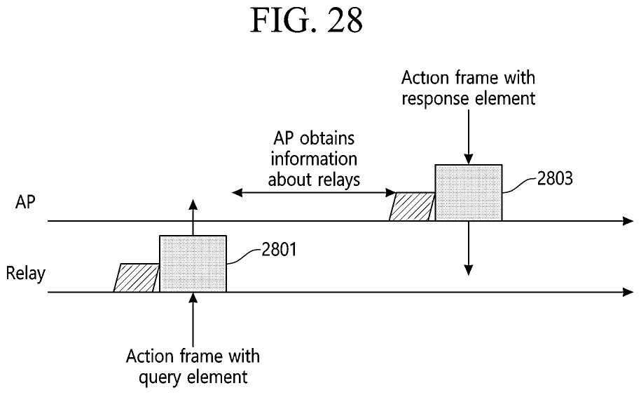

Upon receiving the relay search message, the AP can start a relay search and upon finding the relay search, it can accumulate the responses from the relay and either inform all the possible options and their responses (based on one or more information items such as those described in Table 1) or suggest the best possible relay for the STA. The relay search request can have a format and contents similar to that of the query message described herein. For instance, the STA can transmit an action frame such as the one shown in Table 4 as depicted in FIG. 28. Upon receiving the action frame, the AP can process the action frame, obtain information about the relay(s) if not already available and then provide a response to the STA.

FIG. 28 illustrates an STA side relay search request in accordance with an embodiment. In particular the STA transmits an action frame with a query element 2801 to an AP. The AP can obtain information about relays. The STA can transmit an action frame with a response element 2803 to the STA.

In some embodiments, the procedures and signaling described in this disclosure may be applicable to multi-link operation as well and should not be considered as being limited to single link operation. One or more of the fields in any of the described embodiments can be absent. Additional fields can be present in the various embodiments provided in this disclosure.

Hereinafter, latency reduction for relay operations, including priority access for the relay in accordance with several embodiments are described. In some embodiments, the relay can be provided with priority access to the wireless medium. In some embodiments, the relay can obtain enhanced distributed channel access (EDCA) and/or multi-user (MU) EDCA parameters (hereby referred to as operation parameters) which can be used for channel access during relay operation. The EDCA and/or the MU EDCA parameters can be designed such that they result in a higher priority access to the wireless medium for the relay. In some embodiments, the relay can request the enhanced operation parameters from the AP.

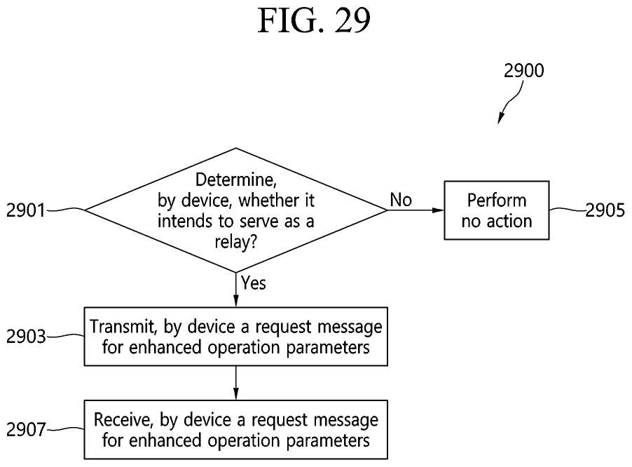

FIG. 29 illustrates a procedure for priority access for relay in accordance with an embodiment. The process 2900 in operation 2901, the device determines whether it intends to serve as a relay. If in operation 2901, the device determines that it does intend to serve as a relay, then in operation 2903 the device transmits a message for enhanced operation parameters. In operation 2907, the device receives a message that includes enhanced operation parameters. If in operation 2901, the device determines that it does not intend to serve as a relay, then in operation 2905 the device performs no action. In some embodiments, the device can transmit a request message to the AP to request for the enhanced operation parameters. The message transmitted by the relay to the AP can include at least one or more of the information items as indicated in Table 7.

TABLE 7

| Information | |
|---|---|
| item | Description |
| Enhanced | An information item that can indicate that indicate the |
| operation | relay's request for enhanced operation parameters. |
| parameters | E.g., a field (e.g., a bit) that can take a particular |
| request | value (e.g., 1) to indicate the request. |
| Request | An information item that can serve as a reference for |
| reference | the request. The responder can use the same reference |
| | when responding. E.g., a dialog token |
| Relay identifier | An information item that can be the relay's identifier. |
| | E.g., MAC address, AID, etc. |
| Reason | An information item that can indicate the reason for |
| information | making the request. E.g., a reason code. |

The above information items can be transmitted together or separately. They can be transmitted as a part of any existing frame/element/field/subfield in the standard or can be a part of newly defined ones.

Upon receiving the above request message, the AP can transmit a response message that can include at least one or more of the information items as indicated in Table 8.

TABLE 8

| Information | |
|---|---|
| item | Description |
| Status | An information item that can indicate the response of the |
| information | AP. E.g., a status code. |
| Request | An information item that can serve as a reference for the |
| reference | request. The responder can use the same reference when |
| | responding. E.g., a dialog token that was used by the |
| | relay when making the request. |
| Enhanced | An information item that can describe the enhanced |
| operation | operation parameters that can be used by the relay. The |
| parameters | enhanced operation parameters can be for each of the links |
| | that are setup by the relay for relay to AP communication. |
| | The enhanced operation parameters can also be used for |
| | communication with STA. |

The above information items can be transmitted together or separately. They can be transmitted as a part of any existing frame/element/field/subfield in the standard or can be a part of newly defined ones.

In some embodiments, if the AP approves the relay's request, then the AP can provide the enhanced operation parameters to the relay. Upon receiving the enhanced operation parameters, the relay can update the operation parameters (EDCA and/or MU EDCA parameters) that the STA is currently using as soon as possible in implementation. The relay can then use the enhanced operation parameters to communicate with the AP and the STA. If the AP denies the relay's request, then the relay can continue to use its current operation parameters without any modifications/changes.

In some embodiments, the AP can transmit the response message in an unsolicited manner to the relay as well. For instance, if the AP assesses that the enhanced operation parameters provided to the relay do not result in higher priority access to the wireless medium, then the AP can send an unsolicited update message that can carry at least one or more of the information items as indicated in Table 8 to the relay to update the relay's operation parameters.

If the relay identifies that the operation parameters provided to it do not result in higher priority, then the relay can transmit another request message to request for an update. The reason code can be set such that the relay's intent for an update to the operation parameters is conveyed to the AP.

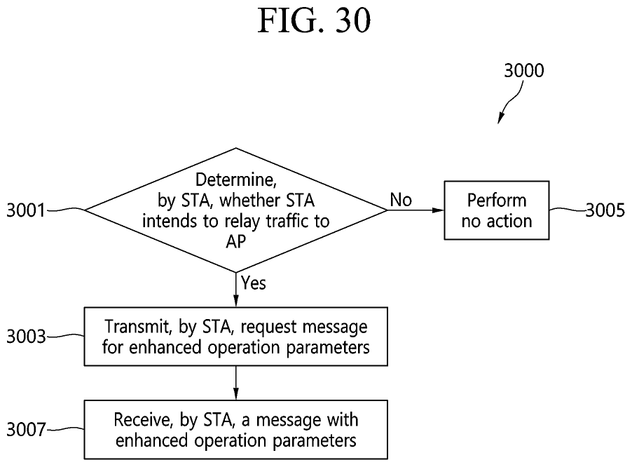

Hereinafter, priority access for the STA in accordance with this disclosure are described. In some embodiments, the STA can be provided with enhanced operation parameters when it communicates with the AP via the relay as shown in FIG. 30 in accordance with an embodiment.

FIG. 30 illustrates a flow chart of an example process for priority access for a STA in accordance with an embodiment. The process 3000 in operation 3001, the STA determines whether it intends to relay traffic to an AP. If in operation 3001, the STA determines that it does intend to relay traffic to the AP, then in operation 3003, the STA can transmit a request message for enhanced operation parameters. In operation 3007, the STA can receive a message with the enhanced operation parameters. If in operation 3001, the STA determines that it does not intend to relay traffic to the AP, then in operation 3003, the STA performs no action. In some embodiments, the STA can transmit a request message to the AP (e.g., as a part of the relay setup) or to the relay (e.g., if done after relay operation has started). The request message can include at least one or more of the information items as indicated in Table 9.

TABLE 9

| Information | |
|---|---|
| item | Description |
| Enhanced | An information item that can indicate that indicate the |
| operation | STA's request for enhanced operation parameters. E.g., |
| parameters | a field (e.g., a bit) that can take a particular value |
| request | (e.g., 1) to indicate the request. |
| Request | An information item that can serve as a reference for |
| reference | the request. The responder can use the same reference |
| | when responding. E.g., a dialog token |
| STA identifier | An information item that can be the STA's identifier. |
| | E.g., MAC address, AID, etc. |
| Reason | An information item that can indicate the reason for |
| information | making the request. E.g., a reason code. |

The above information items can be transmitted together or separately. They can be transmitted as a part of any existing frame/element/field/subfield in the standard or can be a part of newly defined ones.

Upon receiving the above request message, the responder (e.g., AP, relay) can transmit a response message that can include at least one or more of the information items as indicated in Table 10.

TABLE 10

| Information | |
|---|---|
| item | Description |
| Status | An information item that can indicate the response of |
| information | the responder. E.g., a status code. |
| Request | An information item that can serve as a reference for |
| reference | the request. The responder can use the same reference |
| | when responding. E.g., a dialog token that was used by |
| | the relay when making the request. |
| Enhanced | An information item that can describe the enhanced |
| operation | operation parameters that can be used by the relay. |
| parameters | The enhanced operation parameters can be for each of |
| | the links that are setup by the STA for STA to relay |
| | communication. |

The above information items can be transmitted together or separately. They can be transmitted as a part of any existing frame/element/field/subfield in the standard or can be a part of newly defined ones.

If the responder approves the STA's request, then the responder can provide the enhanced operation parameters to the STA. Upon receiving the enhanced operation parameters, the STA can update the operation parameters (EDCA and/or MU EDCA parameters) that the STA is currently using as soon as possible in implementation. The STA can then use the enhanced operation parameters to communicate with the AP and the relay. If the responder denies the STA's request, then the STA can continue to use its current operation parameters without any modifications/changes.

The AP/relay can transmit the response message in an unsolicited manner to the STA as well. For instance, if the AP/relay assesses that the enhanced operation parameters provided to the STA do not result in higher priority access to the wireless medium, then the AP/relay can send an unsolicited update message that can carry at least one or more of the information items as indicated in Table 10 to the STA to update the STA's operation parameters.

If the STA identifies that the operation parameters provided to it do not result in higher priority, then the STA can transmit another request message to request for an update. The reason code can be set such that the STA's intent for an update to the operation parameters is conveyed to the AP/relay.

Hereinafter, priority access for the AP in accordance with this disclosure are described. In some embodiments, the AP can also use the enhanced operation parameters when communicating with STA(s) whose traffic is relayed. The AP can determine the parameters on its own or use the same enhanced operation parameters that the AP provided to the relay and/or the STA.

Hereinafter, procedures to reduce channel access delays/airtime consumption in accordance with this disclosure are described. In some embodiments, an enhanced transmission process can be used by the relay when transmitting traffic to the AP and/or the STA. The process can take advantage of the fact that the relay's transmissions can be heard by both the AP and the STA.

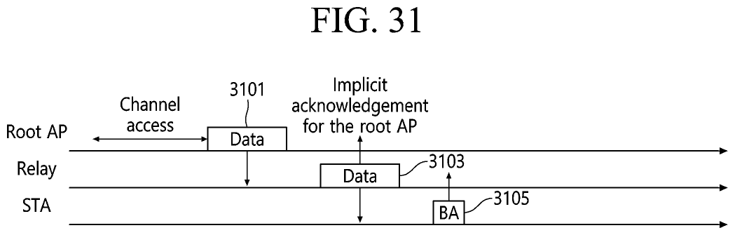

FIG. 31 illustrates an enhanced transmission procedure in accordance with an embodiment. As illustrated in FIG. 31, the AP can obtain channel access and then transmit data 3101 to a relay. Upon completion of reception of the data 3101 from the AP, the relay can transmit the data 3103 to the STA following the data reception from the AP. The relay can skip the acknowledgement (ACK/BA) transmission and directly transmit the data 3103. The STA can transmit an acknowledgement (BA) frame 3105 to the relay. The AP can use the transmission of the data frame as an indication of acknowledgement from the relay. The data 3103 that is transmitted by the relay to the AP and/or the STA can include an additional field in the PHY or the MAC header that can indicate that the data is an implicit acknowledgement for the transmission from the AP. The other STA(s) that hear the data transmission by the relay can set their NAV timers based on the duration value indicated in the data frame transmitted by the relay. In some embodiments, this process may help to reduce the channel access delay as the relay does not need to contend to transmit the frame to the STA. Further, the procedure can also reduce the air-time consumption from transmission of an additional acknowledgement (ACK/BA) frame.

In some embodiments, if the implicit acknowledgement is provided in the MAC header, then for the transmission of the data frame, the relay can choose a rate that is such that it can be decoded by both the AP and the STA. If the implicit acknowledgement is provided in the PHY header, then the relay can choose the transmission rate suited for reception by the STA. When the relay completes its transmission and the STA transmits the BA, the relay can optionally transmit the (skipped) BA to the AP. In some embodiments, the procedure described in FIG. 31 can also be used when relaying data frames from the STA to the AP.

In some embodiments, the procedure can be used based on a number of conditions. Table 11 provides conditions for using the enhanced transmission procedure in accordance with several embodiments.

TABLE 11

| Condition | Description |
|---|---|
| Traffic type | If the traffic the relay is handling is latency sensitive, |
| | then the relay can use the above procedure to avoid an |
| | additional channel access delay. The relay can identify the |
| | traffic type based on TID, traffic classifiers, etc. |
| Traffic | If the data frame that the relay receives has an expiration |
| urgency | time that can get exceeded if the relay chooses to perform |
| | another channel access for transmitting it, then the relay |
| | can use the above procedure. |
| Relay power | If the relay is planning to go into power save mode before |
| save | the channel access for the frame can be completed, then the |
| | relay can skip the channel access and use the above |
| | procedure to deliver the frames early. |
| STA power | If the STA is planning to go into power save mode before |
| saves | the channel access for the frame can be completed, then the |
| | relay can skip the channel access and use the above |
| | procedure to deliver the frames early. |

Hereinafter, negotiation procedures for enhanced transmission in accordance with this disclosure are described. In some embodiments, a negotiation procedure can be used to determine which traffic can be transmitted by the relay by using the enhanced transmission procedure described herein. The negotiation can involve transmission of a request frame which can include at least one or more of the information items as indicated in Table 12.

TABLE 12

| Information | |
|---|---|
| item | Description |
| Traffic | An information item that can provide an indication of |
| indication | which traffic type can be handled by using the |
| | enhanced transmission procedure. E.g., TID bitmap, TID |
| | list, etc. |
| Traffic | An information item that can provide a description of |
| classification | how to identify the traffic that can be handled by |
| criteria | using the enhanced transmission procedure. E.g., |
| | TCLAS element with/without TCLAS processing element. |
| STA | An information item that can provide an indication of |
| identifier | which STA the enhanced transmission procedure can be |
| | used for. E.g., STA MAC address, AID, etc. |
| Request | An information item that can be used as a reference for |
| identifier | the request frame. E.g., a dialog token. |

The above information items can be transmitted together or separately. They can be transmitted as a part of any existing frame/element/field/subfield in the standard or can be a part of newly defined ones.

Upon receiving the request frame, a response frame can be generated. The response frame can include the status of the request frame. E.g., based on an indication made via a status code.

In some embodiments, a dynamic indication can be provided for use of enhanced transmission. In some embodiments, the data frame that is transmitted can itself include a field that can indicate to the relay if the enhanced transmission can be used or not. If such an indication is not made, then the relay can skip the enhanced transmission procedure and handle the frame using the procedures in the baseline spec.

In some embodiments, a relay that can support any of the procedures indicated in this disclosure can make an indication in management frames that it transmits. E.g., if the relay is a Mobile AP/AP, then the relay can make the indication using beacons, probe response frames, among other types of frames that it transmits.

Hereinafter, relay operations with legacy APs, including discovery and connection procedures in accordance with this disclosure are described. In some embodiments, the relay can transmit an AP info message (either on its own or upon request from the STA). The message can include at least one or more of the information items as indicated in Table 13.

TABLE 13

| Information | |
|---|---|
| items | Description |
| Connected AP | An information item that can indicate the list of APs |
| info | that the relay can help to connect to. E.g., list of |
| | AP MAC addresses, BSSIDs, etc. These can be |
| | APs that the relay is directly connected to and/or |
| | indirectly connected to via one or more of the |
| | STAs/MLDs that are collocated on the same device as |
| | the relay. The relay can also be connected to the APs |
| | via a wired network such as an Ethernet |
| | based/controller based backhaul network and can forward |
| | the STAs traffic to such APs over the wired network. |
| AP detailed | An information item that can carry detailed information |
| info | about the APs that are listed in the connected AP info. |
| | E.g., AP's capabilities, bandwidth and channel of |
| | operation, etc. |
| AP constraint | An information item that can indicate any constraints |
| info | that the AP may have. |

The above information items can be transmitted together or separately. They can be transmitted as a part of any existing frame/element/field/subfield in the standard or can be a part of newly defined ones.

In some embodiments, the above AP info message can be carried in an element.

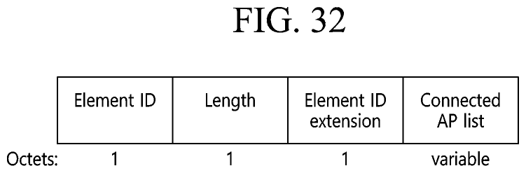

FIG. 32 illustrates an AP info message element format in accordance with an embodiment. The AP info message element format can include an element ID field, a length field, an element ID extension field, and a connected AP list field. The element ID field can provide identification information of the element. The length field can provide length information of the element. The element ID extension field can provide an identifier extension for the element. The connected AP list can be a list of AP MAC addresses that the relay can help the STA to connect and relay traffic to and from.

When STA receives an AP info message, it can understand which APs the relay can help it to connect to. If the AP that the STA wants to connect to is in the list of APs in the relay's message, then the STA can connect to the relay. When making the connection, the STA can include a preferred AP indication message. The preferred AP indication message can include at least one or more of the information items as indicated in Table 14.

TABLE 14

| Information | |
|---|---|
| items | Description |
| Preferred AP | An information item that can indicate the AP that the |
| indication | STA intends to connect to. E.g., the AP's MAC |
| | address, BSSID, etc. |
| STA identifier | An information item that can indicate any identifiers |
| | that have been provided by the AP to the STA during |
| | association. E.g., AID. The relay can use this |
| | information to inform the AP about the STA's |
| | connection. |
| Preferred AP | An information item that can describe the action |
| unavailability | that the relay can take if the connection to the |
| option | preferred AP is not possible after association. E.g., |
| | if after association, if the relay's connection |
| | to the STA's preferred AP is terminated, the |
| | information item can indicate if the STA prefers to |
| | stayconnected to the relay via a different AP or to |
| | terminate its connection. |

The above information items can be transmitted together or separately. They can be transmitted as a part of any existing frame/element/field/subfield in the standard or can be a part of newly defined ones.

When the relay receives a preferred AP indication message from the STA during connection, it can verify if the relay can help the STA to connect to the AP. If it can, it can transmit a preferred AP confirmation message to the STA. The preferred AP confirmation message can include at least one or more of the information items as indicated in Table 15.

TABLE 15

| Information | |
|---|---|
| items | Description |
| Confirmation | An information item that can describe the confirmation that |
| indication | the STA's traffic can be relayed to the preferred AP. |
| | E.g., a status code indicating success when the relay can |
| | forward the STA's traffic to the AP and failure when the |
| | relay cannot. |
| Root AP | An information item that can describe the AP that the relay |
| identifier | will forward the STA's traffic to. |

The above information items can be transmitted together or separately. They can be transmitted as a part of any existing frame/element/field/subfield in the standard or can be a part of newly defined ones.

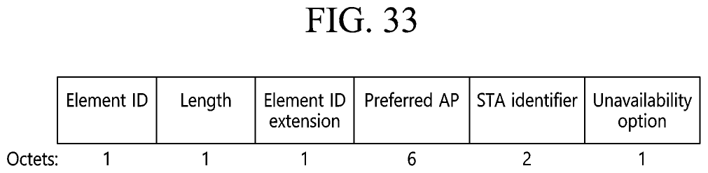

In some embodiments, the preferred AP indication message can have a format as shown in FIG. 33.

FIG. 33 illustrates a preferred AP indication message format in accordance with an embodiment. The preferred AP indication message can include an element ID field, a length field, an element ID extension field, a preferred AP field, a STA identifier field, and a unavailability option field.

The element ID field can provide identification information of the element. The length field can provide length information of the element. The element ID extension field can provide an identifier extension for the element. The preferred AP field can include an information item that can indicate the AP that the STA intends to connect to (e.g., the AP's MAC address, BSSID, etc.). The STA identifier field can include an information item that can indicate any identifiers that have been provided by the AP to the STA during association (e.g., AID). The relay can use this information to inform the AP about the STA's connection. The unavailability option field may include an information item that can describe the action that the relay can take if the connection to the preferred AP is not possible after association. For example, if after association, if the relay's connection to the STA's preferred AP is terminated, the information item can indicate if the STA prefers to stay connected to the relay via a different AP or to terminate its connection.

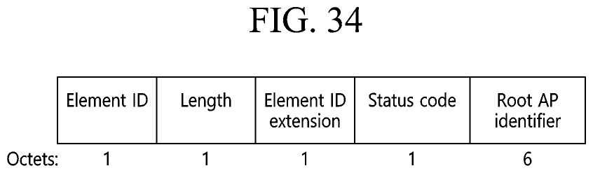

In some embodiments, the preferred AP confirmation message can have a format as indicated in FIG. 34.

FIG. 34 illustrates a preferred AP confirmation message format in accordance with an embodiment. The preferred AP confirmation message format can include an element ID field, a length field, an element ID extension field, a status code field, and a Root AP identifier field.

The element ID field can provide identification information of the element. The length field can provide length information of the element. The element ID extension field can provide an identifier extension for the element. The status code field may include an information item that can describe the confirmation that the STA's traffic can be relayed to the preferred AP. For example, a status code indicating success when the relay can forward the STA's traffic to the AP and failure when the relay cannot. The root AP identifier field may include an information item that can describe the AP that the relay will forward the STA's traffic to.

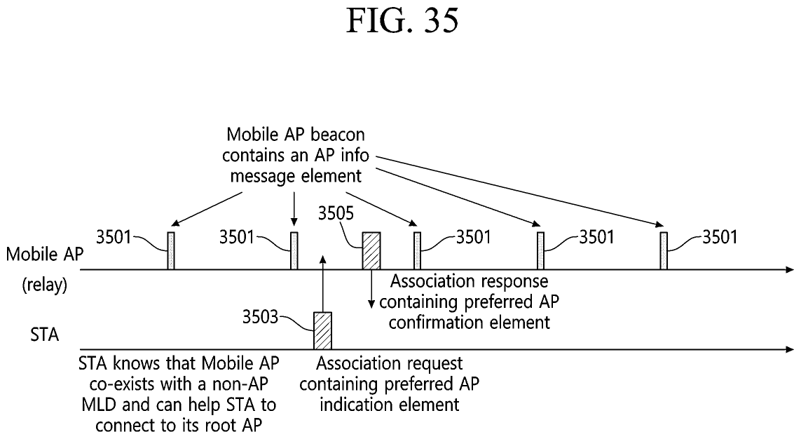

FIG. 35 illustrates the operation when a relay is a mobile AP in accordance with an embodiment. As illustrated in FIG. 35, STA needs to maintain its connection to its root AP. Relay is a Mobile AP and advertises the AP info message element its beacons 3501. When the STA receives a beacon 3501 from the Mobile AP that includes the AP info message element, the STA knows that the Mobile AP can act as a relay for the STA. The STA can then transmit an association request frame 3503 that includes the preferred AP indication element to the relay. Upon receiving the association request frame from the STA, the relay can process the association request frame and transmit an association response frame 3505 that includes the preferred AP confirmation element to the STA.

Hereinafter, AP side STA association status maintenance in accordance with this disclosure are described. In some embodiments, when the STA has established connection with the relay, the relay can transmit an association maintenance request message to the root AP. The association maintenance request message can inform the root AP to keep the STA's association status active. This can help if the STA decides to switch back to the AP at some point. The association maintenance request message can include at least one or more of the information items as indicated in Table 16.

TABLE 16

| Information | |
|---|---|
| item | Description |
| STA identifier | An information item that can indicate any identifiers |
| | that have been provided by the AP to the STA during |
| | association. E.g., AID. The relay can use this |
| | information to inform the AP about the STA's |
| | connection. |
| Duration | An information item that can indicate the duration |
| | for which the association status of the STA needs |
| | to be maintained. |
| Indefinite | An information item that can indicate if the |
| maintenance | STA's association status at the AP needs to be |
| indication | maintained indefinitely unless the AP is informed |
| | by the relay or the STA to not do so. |

The above information items can be transmitted together or separately. They can be transmitted as a part of any existing frame/element/field/subfield in the standard or can be a part of newly defined ones.

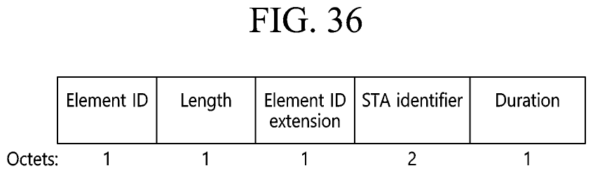

In some embodiments, the above signaling can be performed by using a vendor specific element. The element can have a format as shown in FIG. 36.

FIG. 36 illustrates a vendor specific element format in accordance with an embodiment. The vendor specific element may include an element ID field, a length field, an element ID extension field, an STA identifier field, and a duration field. The element ID field can provide identification information of the element. The length field can provide length information of the element. The element ID extension field can provide an identifier extension for the element.

The STA identifier field may include an information item that can indicate any identifiers that have been provided by the AP to the STA during association (e.g., AID). The relay can use this information to inform the AP about the STA's connection. The duration field may include an information item that can indicate the duration for which the association status of the STA needs to be maintained.

In some embodiments, when the STA's connection with the relay is terminated, the STA can transmit a switch message to the relay. The switch message can indicate the AP that the STA intends to switch to upon termination of the connection with the relay.

The relay can transmit a STA status change info message to the root AP. The status change info message can include at least one or more of the information items as indicated in Table 17.

TABLE 17

| Information | |
|---|---|
| item | Description |
| STA identifier | An information item that can indicate any identifiers |
| | that have been provided by the AP to the STA during |
| | association. E.g., AID. The relay can use this |
| | information to inform the AP about the STA's |
| | connection. |
| Status indication | An information item that can indicate the status |
| | of the STA's connection with the relay. |
| Next AP | An information item that can indicate the AP that |
| identifier | the STA transitions to. If the AP is different from |
| | the root AP, then the root AP can disassociate the |
| | STA. |

The above information items can be transmitted together or separately. They can be transmitted as a part of any existing frame/element/field/subfield in the standard or can be a part of newly defined ones.

Hereinafter, disconnection procedures in accordance with this disclosure are described. In some embodiments, if the STA has indicated that after association, if the relay's connection to the STA's preferred AP is terminated, whether the STA prefers to stay connected to the relay via a different AP or to terminate its connection, then the relay can take an action appropriately. If the STA has indicated that it prefers to terminate its connection to the AP, then the relay can transmit terminate its connection with the STA and transmit a reason code to the STA indicating the reason for the disconnection. If the STA has indicated that it prefers to stay connected to the relay, the relay can transmit a message to the root AP of the STA to inform the root AP about the STA's changed connection status. The root AP can then disassociate with the STA. When the STA is disconnected with the relay, the STA can either try to switch back to its original root AP or the STA can try to connect to a new AP.

In some embodiments, a relay that can relay the STA's traffic to a legacy AP can advertise its capability in one or more frames that it transmits. These frames can be management frames such as beacons, probe responses, association responses, among others or in control frames upon request from the STA.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, the first STA comprising:
a memory;
a processor coupled to the memory, the processor configured to:
determine a relay node that can perform one or more relay operations to communicate with the first STA;
transmit, to a second STA, a first frame that includes information regarding the relay node that can be used to communicate with the first STA; and
communicate with the second STA via the first relay node.

2. The first STA of claim 1, wherein the first STA is an access point (AP) and the second STA is a non-AP STA.

3. The first STA of claim 1, wherein, to communicate with the second STA, the processor is further configured to: receive a second frame from the second STA that has been forwarded by the relay node.

4. The first STA of claim 1, wherein the processor is further configured to receive, from the relay node, a second frame that includes information regarding capabilities of the relay node.

5. The first STA of claim 1, wherein the processor is further configured to receive, from the relay node, a second frame that includes information on one or more access points (APs) and STAs that can communicate with the relay node.

6. The first STA of claim 5, wherein the second STA is included in the information in the second frame.

7. The first STA of claim 1, wherein the first frame includes information on a plurality of relay nodes that can be used to connect to the first STA.

8. The first STA of claim 1, wherein the first frame includes signal strength information and communication speed information for the relay node.

9. The first STA of claim 1, wherein the processor is further configured to transmit a second frame to one or more STAs that advertises one or more relay nodes that can be used to communicate with the first STA.

10. The first STA of claim 1, wherein the processor is further configured to:
transmit a second frame to one or more STAs to check which of the one or more STAs can perform relay operations to relay communications to the first STA; and
receive a third frame from a third STA in the one or more STAs that indicates that the third STA can perform relay operations to relay communications to the first STA.

11. A relay node in a wireless network, the relay node comprising:
a memory;
a processor coupled to the memory, the processor configured to:
determine an ability to perform one or more relay operations to communicate with one or more STAs;
transmit, to a first STA, a first frame that includes information regarding the one or more STAs the relay node can communicate with;
receive, from the first STA, a second frame that is to be transmitted to a second STA; and
transmit, to the second STA, the second frame.

12. The relay node of claim 11, wherein the relay node is an access point (AP) and the first STA is a non-AP STA.

13. The relay node of claim 11, wherein the first frame includes information regarding capabilities of the relay node.

14. The relay node of claim 11, wherein the second STA is included in the information regarding one or more STAs that the relay node can communicate with.

15. The relay node of claim 11, wherein the first frame includes signal strength information and communication speed information for the relay node.

16. A computer-implemented method for facilitating communication at a first station (STA) in a wireless network, the method comprising:
determining a relay node that can perform one or more relay operations to communicate with the first STA;
transmitting, to a second STA, a first frame that includes information regarding the relay node that can be used to communicate with the first STA; and
communicating with the second STA via the first relay node.

17. The computer-implemented method of claim 16, wherein the first STA is an access point (AP) and the second STA is a non-AP STA.

18. The computer-implemented method of claim 16, further comprising receiving, to communicate with the second STA, a second frame from the second STA that has been forwarded by the relay node.

19. The computer-implemented method of claim 16, further comprising receiving, from the relay node, a second frame that includes information regarding capabilities of the relay node.

20. The computer-implemented method of claim 16, further comprising receiving, from the relay node, a second frame that includes information on one or more access points (APs) and STAs that can communicate with the relay node.
